(19) United States
(12) Patent Application Publication
(10) Pub. No.: US 2011/0163152 A1
(43) Pub. Date: Jul. 7, 2011

(54) METHOD OF FORMING SOLDER DAM

(75) Inventors: Masayuki KITAJIMA, Kawasaki (JP); Yutaka NODA, Kawasaki (JP); Hidehiko KOBAYASHI, Kawasaki (JP); Toshihiro KUSAGAYA, Shinagawa (JP); Kazuhiro MIZUKAMI, Shinagawa (JP)

(73) Assignees: FUJITSU LIMITED, Kawasaki-shi (JP); FUJITSU COMPONENT LIMITED, Tokyo (JP)

(21) Appl. No.: 12/974,576

(22) Filed: Dec. 21, 2010

(30) Foreign Application Priority Data
Jan. 5, 2010 (JP) 2010-000697

(51) Int. Cl. B23K 1/20

(52) U.S. Cl. 228/176

(57) ABSTRACT

A method of forming a solder dam on a lead of an electronic component includes forming the looped solder dam surrounding a target lead, to which the solder dam is to be formed, of a plurality of leads connected to the electronic component, by fitting a C-shaped fitted member to the target lead at a predetermined location.

### CROSS-REFERENCE TO RELATED APPLICATION

This application is based upon and claims the benefit of priority of the prior Japanese Patent Application No. 2010-000697, filed on Jan. 5, 2010, the entire contents of which are included herein by reference.

### FIELD

The embodiments discussed herein are related to a technique to form a solder dam on a lead of an electronic component.

### BACKGROUND

The reflow process is known as one of techniques for mounting electronic components on a printed board. In the reflow process, after placing electronic components on a substrate on which a pasteous solder has been applied or printed, the entire substrate is heated in an oven, known as a reflow oven, to cause melting of the solder, thereby soldering leads of the electronic components to predetermined locations on the substrate. The reflow oven has a far-infrared heater, a hot air heater, or the like, for example, incorporated therein, so that the solder on the substrate can uniformly melt.

The wettability of a molten solder (how easily the solder flows and spreads) varies, depending on the temperature at the location where the solder adheres. In the meantime, even if the temperature within the reflow oven is controlled to be uniform, the temperature of leads is sometimes increased beyond the temperature of lands on the substrate to which the heads are to be attached to, due to difference in the heat capacities of the substrate and the lead. In such as case, the molten solder on the substrate tends to move toward a resin package of an electronic component through the surface of a lead, the phenomenon generally being referred to as “solder wicking”, which may cause a contact failure between the lead and the land on the printed board.

To address this issue, a technique for preventing solder wicking by forming a solder resist layer on the surfaces of leads is known. In this technique, after leads are dipped into a liquid solder resist to a form resist layer film on the surfaces of leads, the resist layer at the tips of the leads is removed using a stripping solution to form solder contact portions. In other words, this technique attempts to prevent solder wicking by covering the leads with a resist layer, except for the tips of the leads.

Another technique is also known for preventing solder wicking in which fluorine or silicone is applied on leads. More specifically, solder-repellent coating (which behaves as a solder dam) are provided on leads to prevent the solder from wetting on the leads and wicking from the tips of the leads toward the bases (refer to JP-A-2000-261134, for example).

However, the former technique may incur an increase in the manufacturing cost, since a resist layer is formed even at the locations where solder dams are undesirable and thus some portion of the resist layer needs to be removed, which is wasteful. In addition, since the remaining resist layer is left as solder dams, dimensional accuracy of the solder dams is affected by various factors, such as the viscosity of the solder resist, the concentration of the stripping solution, and how precise the stripping solution can be applied. This makes accurate and precise formation of minuscule solder dams difficult, rendering this technique unsuitable for fine-pitched leads.

In addition, the latter technique has difficulty in forming minuscule solder dams since the dimensional accuracy of the solder dam is dependent on how precise fluorine or silicone can be applied.

### SUMMARY

According to an embodiment of the invention, a method of forming a solder dam on a lead of an electronic component includes forming the looped solder dam surrounding a target lead, to which the solder dam is to be formed, of a plurality of leads connected to the electronic component, by fitting a C-shaped fitted member to the target lead at a predetermined location.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF THE DRAWINGS

FIG. 1A is an overall perspective view of a semiconductor package manufactured by a method of forming a solder dam according to an embodiment;

FIG. 1B is an enlarged perspective view of the main portion of the semiconductor package manufactured by the method of forming a solder dam according to an embodiment;

FIG. 2 is a perspective view illustrating the entire construction of a solder dam formation apparatus adapting a method of forming a solder dam according to a first embodiment;

FIG. 3 is a perspective view illustrating a ring member used in the method of forming a solder dam according to the first embodiment;

FIG. 4 is a perspective view illustrating an enlarged view of the main portion of the solder dam formation apparatus in FIG. 2;

FIG. 5A is a diagram illustrating the method of forming a solder dam according to the first embodiment, which is top view of a ring member before being attached on a lead, together with a retention hand;

FIG. 5B is a diagram illustrating the method of forming a solder dam according to the first embodiment, which is a perspective view illustrating attachment of the ring member by the retention hand;

FIG. 5C is a diagram illustrating the method of forming a solder dam according to the first embodiment, which is a perspective view illustrating the lead on which the ring member is brazed;

FIG. 6 is a process chart illustrating the method of forming a solder dam according to the first embodiment;

FIG. 7A is a drawing illustrating an example of mount of a semiconductor package manufactured by the method of forming a solder dam according to the first embodiment, illustrating the example of surface mount;

FIG. 7B is a drawing illustrating an example of mount of a semiconductor package manufactured by the method of forming a solder dam according to the first embodiment, illustrating the example of through-hole mount;

FIG. 8A is an overall perspective view illustrating the construction of a solder dam formation apparatus adapting a method of forming a solder dam according to a second embodiment;

FIG. 8B is a drawing illustrating the construction of the solder dam formation apparatus adapting the method of forming a solder dam according to the second embodiment, which is a transverse cross-sectional view of a second tightening member used for tightening;

FIG. 9A is a perspective view illustrating the method of forming a solder dam according to the second embodiment, illustrating the lead to which the tightened member is tightened;

FIG. 9B is a perspective view illustrating the method of forming a solder dam according to the second embodiment, illustrating the lead fitted with the tightened member that is heated;

FIG. 10 is a process chart illustrating the method of forming a solder dam according to the second embodiment;

FIG. 11 is a perspective view illustrating the construction of a solder dam formation apparatus adapting a method of forming a solder dam according to a third embodiment;

FIG. 12 is a transverse cross-sectional view illustrating the method of forming a solder dam according to the third embodiment;

FIG. 13 is a process chart illustrating the method of forming a solder dam according to the third embodiment; and

FIG. 14 is a perspective view of a lead frame used in a method of forming a solder dam according to a variant.

### DESCRIPTION OF EMBODIMENTS

Hereinafter, embodiments of a method of forming a solder dam will be described with reference to the drawings. Note that the embodiments described below are described by way of example only, and various modifications and applications of techniques that are not provided explicitly in the following embodiments are not intended to be excluded. That is, the present embodiments can be practiced in various ways (by combining embodiments and variants, for example) without departing from the spirit thereof.

### 1. First Embodiment

### 1-1. Overview of Solder Dam

A solder dam formation apparatus adapting a method of forming a solder dam according to a first embodiment is configured to form a solder dam on a lead of an electronic component. Here, the term “solder dam” refers to a portion which is formed from a material which is resistant to adhesion of a solder (solder-repellant material) and serves to dam up the flow of the molten solder.

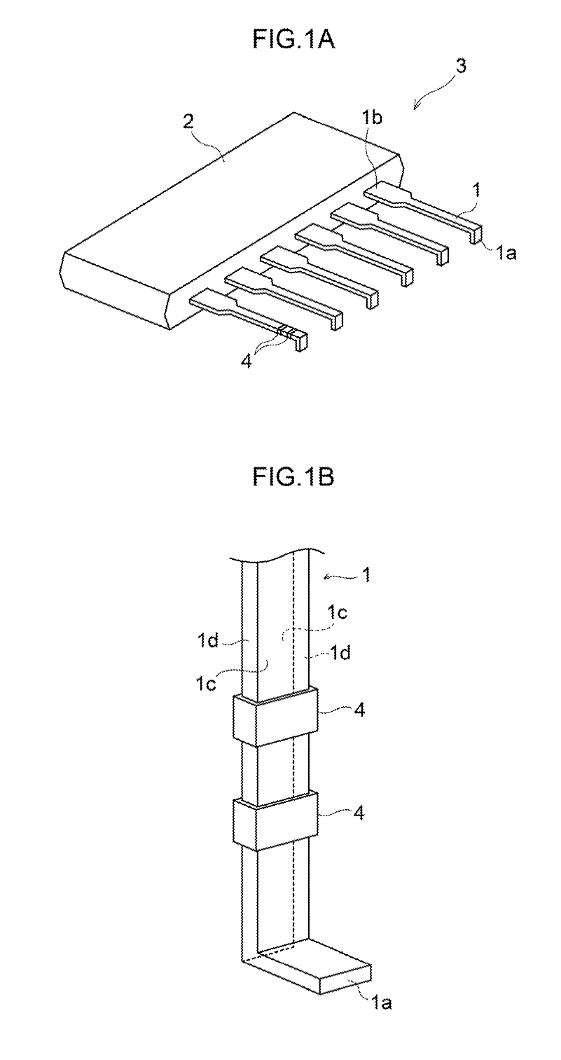

For example, as depicted in FIGS. 1A and 1B, looped solder dams 4 are formed on a lead 1 somewhere midway along the length of the lead 1 extending outwardly from a resin package 2 of a semiconductor package 3 (electronic component), such that the lead 1 is split into the tip end 1a side and the base end 1b side. The solder dams 4 can be regarded as surfaces for restricting physical displacement of the solder (wicking and creeping up of the solder from the tip end 1a side of the lead 1 toward the base end 1b side).

As depicted in FIG. 1B, the lead 1 is a plate member formed by die-cutting of a metal plate with a minuscule die (stamping). Hereinafter, the surface portions will be referred to as “surfaces 1c”, whereas the cuts formed through the plate width (smaller surface area portions) will be referred to as “side cuts ld”. The solder dams 4 are formed both on the surface 1c and on the side cuts ld.

Note that multiple solder dams 4 may be provided on the lead 1 in order to prevent solder wicking more effectively. For example, in the example illustrated in FIG. 1B, a pair of solder dams 4 are formed around the lead 1. In this case, even if some solder flows over the one solder dam on the tip end 1a side of the lead 1, the other solder dam 4 on the base end 1b side can prevent the solder from being wicked any further.

### 1-2. Construction

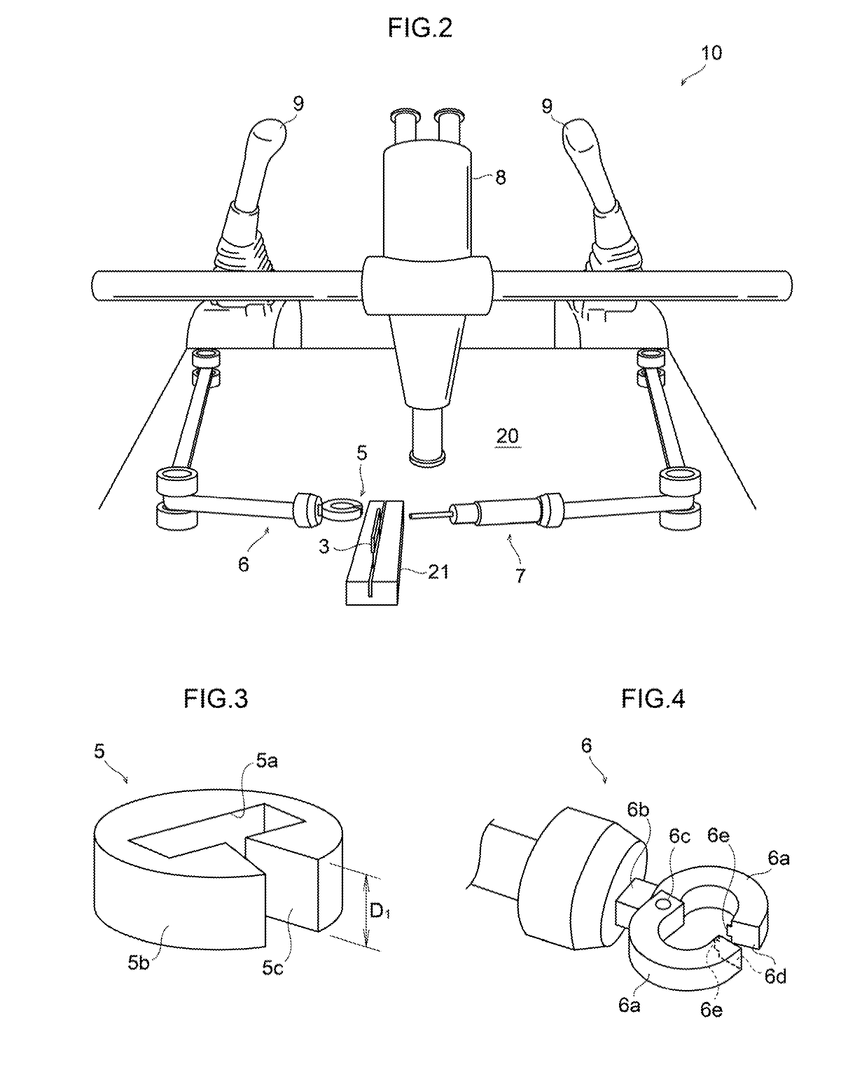

FIG. 2 is a diagram illustrating one example of the construction of a solder dam formation apparatus 10. The solder dam formation apparatus 10 is an apparatus that forms solder dams 4 by fitting C-shaped rings 5 (fitted members) at predetermined locations on a certain lead 1 (target lead) of a group of multiple leads extending from the semiconductor package 3.

Each ring member 5 is made from a metal, and has a through-hole 5a, a side portion 5b, and a cut-out portion 5c, as depicted in FIG. 3.

The through-hole 5a is a space having a rectangular column shape, and is sized and dimensioned so as to correspond to the outer shape of the lead 1. Thus, the through-hole 5a is shaped so as to be closely fitted on the lead 1. The side portion 5b has a cylindrical surface. Note that the longitudinal axis of the through-hole 5a is parallel to the longitudinal axis of the cylindrical shape defined by the side portion 5b. The cut-out portion 5c is a cut-out formed by cutting a portion spanning between the through-hole 5a and the side portion 5b. The surfaces of the cut-out portion 5c span between the surface of the through-hole 5a and the surface of the side portion 5b. The ring member 5 has a so-called C-shape, when viewed from the direction along the longitudinal axis of the through-hole 5a.

The material of the ring member 5 is suitably selected from one of nickel (Ni), aluminum (Al), beryllium (Be), chromic (Cr) molybdenum (Mo), niobium (Nb), titanium (Ti), tungsten (W), zirconium (Zr), and a stainless steel (SUS), or an alloy of any combination of such metals. These metals can inherently prevent adhesion of a solder (or an oxidized film formed in the air can prevent adhesion). The thickness D₁ (i.e., the height in the direction along the longitudinal axis of the through-hole 5a) of the ring member 5 can be set to any suitable value, in accordance with the desirable dam width of the solder dams 4 to be formed. Preferably, the thickness D₁ is set in a range from 0.1 mm to 1.0 mm.

The solder dam formation apparatus 10 includes a retention hand 6, a welding rod 7, a magnifying microscope 8, manipulators 9, a working table 20, and a securing device 21.

The retention hand 6 is a manually operable articulated robot arm having a base secured on the working table 20, which is operated in response to operation inputs to the manipulators 9. The tip of the retention hand 6 is equipped with a pair of movable parts 6a, an arm 6b, a supporting pivot 6c, gripping surfaces 6d, and nails 6e, as depicted in FIG. 4.

The movable parts 6a are each formed in a semi-circular arc, and one ends of the movable parts 6a are movably connected to the arm 6b via the supporting pivot 6c. The gripping surfaces 6d are formed on the other ends of the movable parts 6a. The pair of movable parts 6a are disposed with their gripping surfaces 6d facing with each other. The retention hand 6 holds an object between the pair of gripping surfaces 6d by allowing rotation of the pair of movable parts 6a. In addition, the nails 6e for expanding the cut-out portion 5c in the ring member 5 are formed so as to protrude outwardly on the gripping surfaces 6d at the end closer to the supporting pivot 6c.

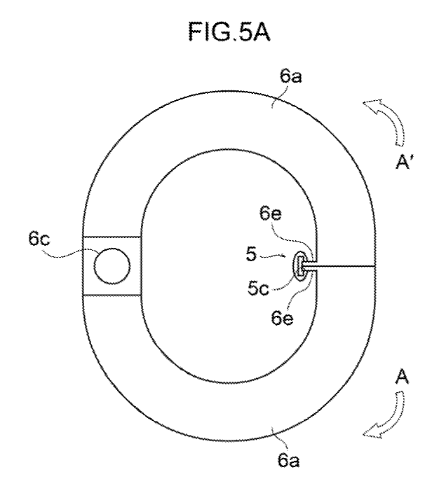

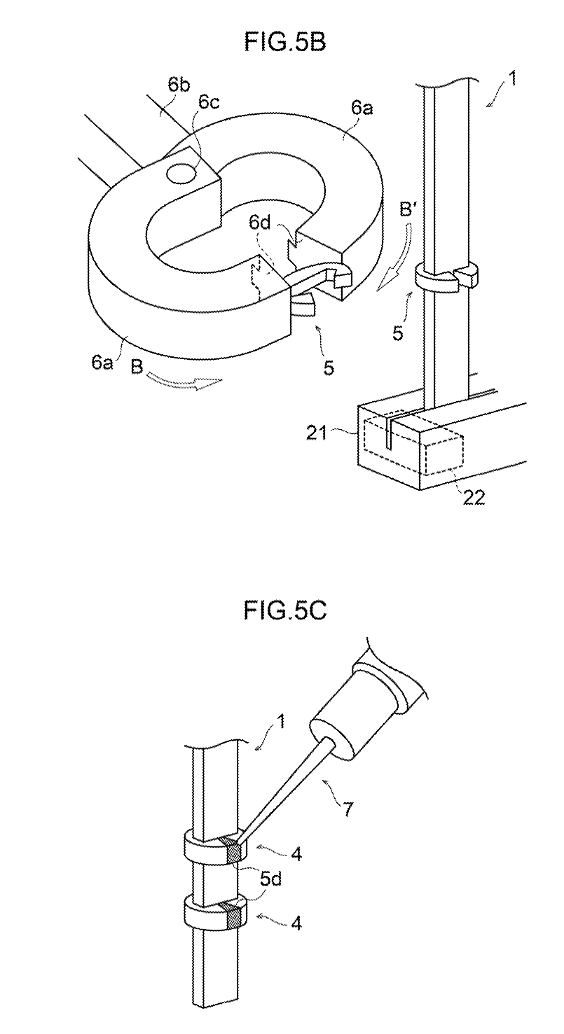

For example, as depicted in FIG. 5A, when the nails 6e are inserted into the cut-out portion 5c in the ring member 5 and the pair of movable parts 6a are rotated in the directions of Arrows A and A′, respectively, the ring member 5 plastically deforms, thereby expanding the gap in the cut-out portion 5c. Expanding the cut-out portion 5c facilitates attachment of the ring member 5 to the lead 1.

Thereafter, as depicted in FIG. 5B, the ring member 5 is attached to the lead 1 at a predetermined location while being held between the gripping surfaces 6d. When the pair of movable parts 6a are rotated in the direction of Arrows B and B′, respectively, while the lead 1 is set in the through-hole 5a, the ring member 5 plastically deforms, thereby narrowing the gap of the cut-out portion 5c. As a result, the ring member 5 is secured to the lead 1, having a gap defined in the ring member 5.

The welding rod 7 is a device that welds the cut-out portion 5c for the purpose of filling the gap in the ring member 5 after the ring member 5 is secured to the lead 1, and operates in response to operation inputs to the manipulators 9. The term “welding” as used herein refers to brazing that melts only the ring member 5, without causing melt of the lead 1, which is the base material, thereby securing the ring member 5 to the surface of the lead 1. It is possible to control the temperature of the tip of the welding rod 7 so as to be higher than the melting point of the ring member 5.

For example, as depicted in FIG. 5C, when the tip of the welding rod 7 at an elevated temperature is made contact to the cut-out portion 5c in the ring member 5, the metal in the vicinity of the cut-out portion 5c melts and flows to fill the gap, thereby forming a brazed portion 5d. As a result, the ring member 5 is welded and fixed firmly to the lead 1, and looped solder dams 4 surrounding the lead 1 (i.e., surrounding all of the surfaces 1c and side cuts 1d) is thus formed.

The magnifying microscope 8 is a device for an operator to operate the manipulators 9 to visually identify locations at which solder dams 4 are to be formed. The operator attaches the ring member 5 to the lead 1 by operating the retention hand 6 and the welding rod 7 using the manipulators 9 while looking through the magnifying microscope 8.

A semiconductor package 3 is secured on the securing device 21 provided on the working table 20. The securing device 21 has a cooler 22 included therein, as depicted in FIG. 5B. The semiconductor package 3 is sandwiched in the securing device 21, in the orientation such that leads 1 extend in the vertical direction, thereby secured to the working table 20. The cooler 22 is a device that cools the leads 1 during brazing by the welding rod 7. For example, the portions of the securing device 21 holding the lead 1 is cooled by any cooling mechanism, and the entire lead 1 is thereby cooled by heat conduction.

### 1-3. Process Chart

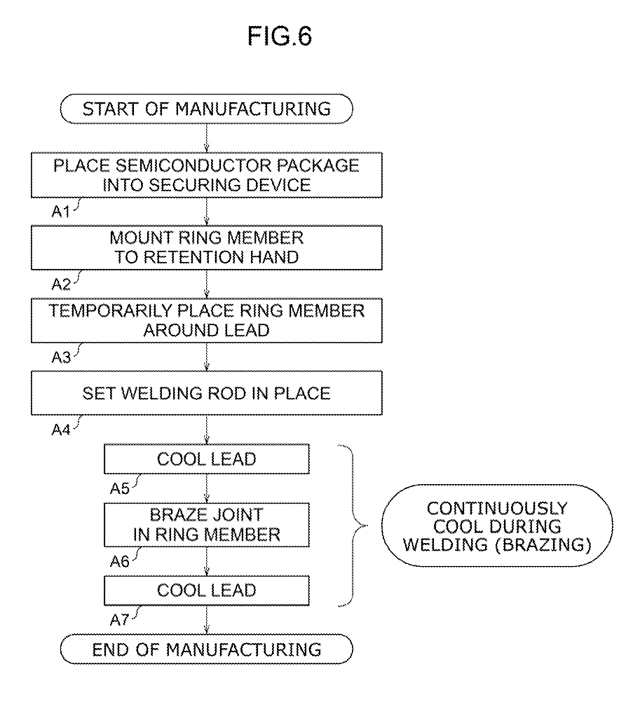

FIG. 6 is a process chart (production flow chart) illustrating one example of a method of forming a solder dam. In this chart, controls in a single control cycle for forming solder dams 4 are arranged chronologically.

In Step A1, a semiconductor package 3 is secured to a securing device 21. In this example, leads 1 are secured to a working table 20.

Thereafter, an operator operates manipulators 9 to mount a ring member 5 to a retention hand 6 (Step A2). In this example, after a cut-out portion 5c in the ring member 5 is expanded by nails 6e of the retention hand 6, the ring member 5 is held between gripping surfaces 6d. Note that “mount” means preparing for attachment of the ring member 5 to a lead 1. In subsequent Step A3, the ring member 5 is attached to the lead 1. In this step, the ring member 5 is temporarily placed on the lead 1, but there is still a gap in the cut-out portion 5c. In addition, the location where the ring member 5 is secured may be fine adjusted in this step, where necessary.

In Step A4, the manipulators 9 are operated by the operator to set the tip of the welding rod 7 in place. In this step, the tip of the welding rod 7 is moved to the location where the tip of the welding rod 7 abuts against (contacts with) the cut-out portion 5c in the ring member 5.

In subsequent Step A5, the cooler 22 is operated to initiate cooling of the lead 1. In subsequent Step A6, the tip of the welding rod 7 is heated to an elevated temperature to braze the gap in the ring member 5, thereby forming looped solder dams 4. In this step, the ring member 5 is fixed to the lead 1.

Note that cooling of the lead 1 by the cooler 22 is also continued during this step, in order to prevent the lead 1 from being curled or bent due to the heat of the welding rod 7. The cooler 22 is continuously operated to cool the lead 1 in subsequent Step A7, until the filled gap in the ring member 5 is cooled. In the process described above, the semiconductor package 3 having solder dams 4 formed on the leads 1 is manufactured.

### 1-4. Applications

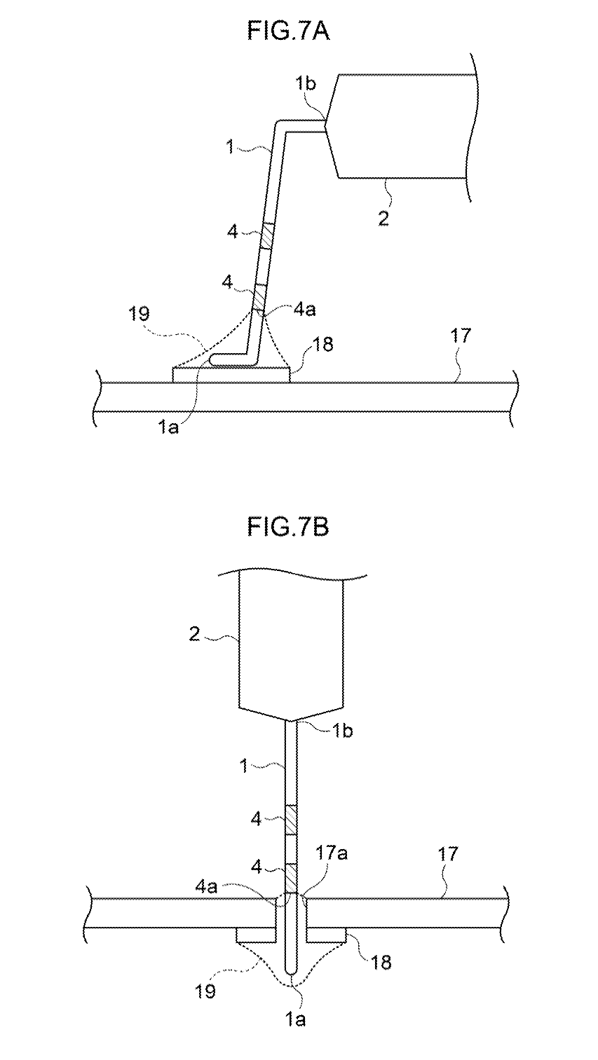

Examples of mount of a semiconductor package 3 having solder dams 4 formed by the above-described process are depicted in FIGS. 7A and 7B.

In the case of surface mount, as depicted in FIG. 7A, after the tip end 1a of a lead 1 that is bent at a substantially right angle is placed on a land 18 on a printed board 17, the tip end 1a is soldered to the land 18. During this process, even if the solder molten on the land 18 wicks up toward a resin package 2 along the surfaces 1c and side cuts ld of the lead 1 due to a certain condition, such as the temperature, the solder is prevented from going beyond the solder dams 4 formed midway on this path since the solder dams 4 are solder-repellant.

Thereby, the solder is confined below the lower end 4a of the solder dam 4, and a solder fillet 19 having a desirable shape is formed, as depicted in the broken lines in FIG. 7A.

In the case of through-hole mount, as depicted in FIG. 7B, after a lead 1 is inserted through a through-hole 17a formed through a printed board 17 in the thickness direction, the tip end 1a of the lead 1 is soldered to a land 18 on a printed board 17. During this process, even if the solder goes through the through-hole 17a and wicks up toward a resin package 2 along the surfaces 1c and side cuts 1d of the lead 1 due to a certain condition, such as the temperature, the solder is prevented from going beyond the solder dams 4 formed somewhere midway on this path.

Accordingly, the solder is confined below the lower end 4a of the solder dam 4, and a solder fillet 19 having a desirable shape is formed, as depicted in the broken lines in FIG. 7B.

### 1-5. Effects

The effects achieved by the above-described first embodiment will be discussed.

Fitting solder-repellent C-shaped ring members 5 on a lead 1 at predetermined locations can increase the precisions of the dislocation and the width of the solder dams 4. More specifically, the locations at which the solder dams 4 are to be formed can be fine adjusted before brazing the ring members 5 (for example, in Step A4), and accordingly the precision of dislocation can be easily improved. In addition, since the width of the solder dams 4 is determined by the thickness D₁ of the ring members 5, the precision of formation of the solder dams 4 can be significantly improved as the precision of manufacturing of the ring members 5 increases.

Furthermore, by selecting a lead 1 on which a ring member 5 is to be brazed using the manipulators 9, a solder dam 4 can be provided only to that particular lead 1 of multiple leads 1 protruding from the semiconductor package 3. For example, it is made possible to form solder dams on a ground lead line which is more susceptible to solder wicking during mounting of the semiconductor package 3 to a printed board 17.

Note that ring members 5 having a greater thickness D₁ provide wider solder dams 4, whereas ring members 5 having a smaller thickness D₁ provide narrower solder dams 4. Accordingly, the thickness D₁ of ring members 5 can be set to any desirable value, depending on the requirement on the width of solders dams 4. More preferably, the thickness D₁ of the ring member 5 is set in a range from 0.1 mm to 1.0 mm. Within this range, minuscule solder dams 4 can be formed while maintaining the strength, durability, and workability required for the ring members 5.

### 2. Second Embodiment

### 2-1. Construction

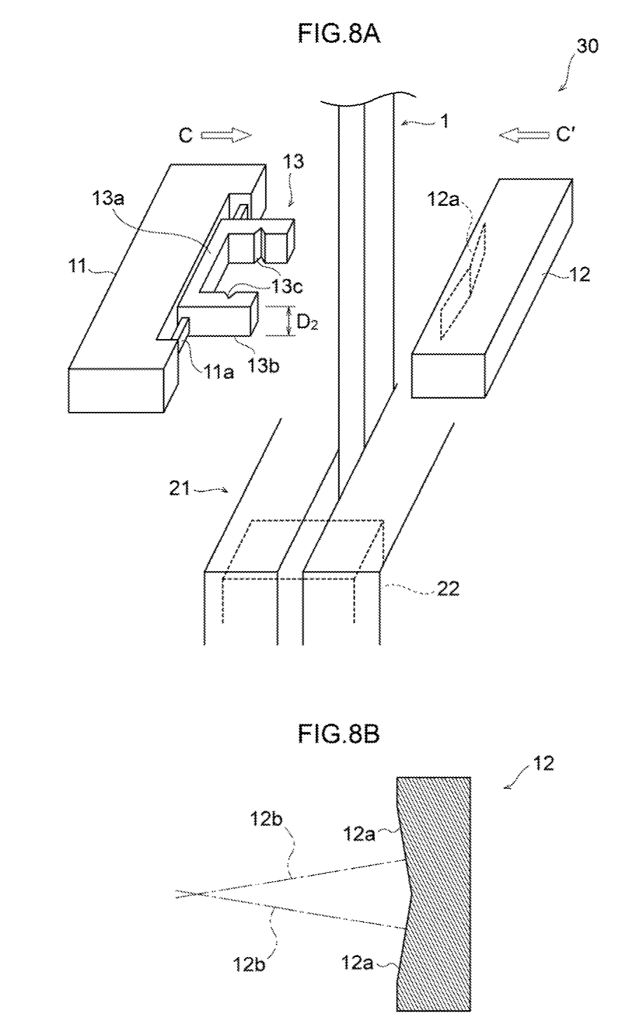

A solder dam formation apparatus 30 adapting a method of forming a solder dam according to a second embodiment will be described with reference to FIGS. 8A and 8B. While ring members 5 are secured to a lead 1 by means of welding (brazing) in the first embodiment, tightened members 13 are secured to a lead 1 by means of tightening (mechanical fastening) in the second embodiment.

Tightened members 13 (fitted members) are made from a metal. As depicted in FIG. 8A, a tightened member 13 is formed in a squared-C shape having three rectangular surfaces, and has an abutted portion 13a and a pair of bent portions 13b extending in parallel with each other from the two ends of the abutted portion 13a. The abutted portion 13a is configured to contact one of the surfaces 1c of the lead 1, and the bent portions 13b are configured to contact the side cuts 1d and the other surface 1c. Notches 13c are formed by cutting the bent portions 13b somewhere midway between the base end and the tip end of the bent portions 13b, and the notches 13c of the bent portions 13b are located so as to face with each other. The bent portions 13b are shaped to facilitate inward bending of the bent portions 13b at the notches 13c.

Various types of metals or alloys, similar to those used for ring members 5, can be used for the tightened members 13. The thickness D₂ of the tightened members 13 (i.e., the size in the direction perpendicular to the direction in which the bent portions 13b protrude from the abutted portion 13a, and in the direction perpendicular to the direction in which the abutted portion 13a extends) can be set to any suitable value, in accordance with the desirable dam width of the solder dams 4 to be formed. Preferably, the thickness D₂ is set in a range from 0.1 mm to 1.0 mm.

A solder dam formation apparatus 30 includes a first tightening member 11 and a second tightening member 12. The tightened member 13, together with the lead 1, is sandwiched between and pressed against the first and second tightening members 11 and 12, thereby being fastened to the lead 1. The directions of pressing by the first and second tightening members 11 and 12 are indicated by Arrows C and C′ in FIG. 8A. Note that the first and second tightening members 11 and 12 are guided on predefined rails secured at predetermined locations, and their loci are on a single straight line (or a single curved line). Similar to the first embodiment, the semiconductor package 3 is secured to a securing device 21 disposed on a working table 20.

The first tightening member 11 is configured to hold the tightened member 13. Between the first tightening member 11 and the tightened member 13, spacers 11a are interposed for adjusting the location of the tightened member 13 in the direction perpendicular to the pressing directions C and C′. In addition, the second tightening member 12 is configured to bend the bent portions 13b of the tightened member 13 held by the first tightening member 11 to secure the tightened member 13 to the lead 1.

The portion of the second tightening member 12 that abuts against the tips of the bent portions 13b is provided with a depressed portion 12a that guides the bent portions 13b to be bended toward the inside of the tightened member 13. The depressed portion 12a has two differently sloped faces, as depicted in FIG. 8B. The two faces abut against the respective tips of the pair of bent portions 13b and apply pressing force to bend the bent portions 13b, and the slopes of the faces are defined such that the normal lines 12b of the respective faces intersect with each other, the intersection facing the first tightening member 11. In other words, the normal line 12b of the face abutting one of the bent portions 13b is inclined toward the other bent portion 13.

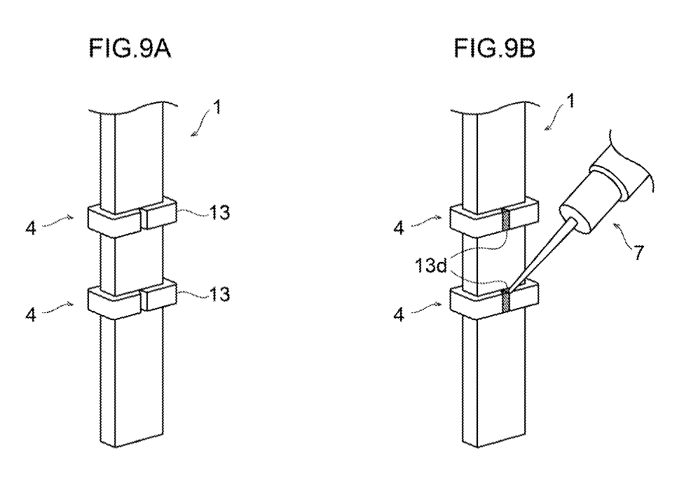

Thereby, as depicted in FIG. 9A, for example, looped solder dams 4 are formed by tightened members 13 that are fitted and tightened on the lead 1 so as to surround the lead 1 (i.e., so as to surround all of the surfaces 1c and the side cuts 1d). Note that sometimes a tightened member 13 is fixed to the lead 1 with a gap defined in the tightened member 13, since the tips of the pair of bent portions 13b are not attached together. Accordingly, the material in the vicinity of the gap may be melt using a welding rod 7 in the first embodiment to form a brazed portion 13d, as depicted in FIG. 9B, for example.

### 2-2. Process Chart

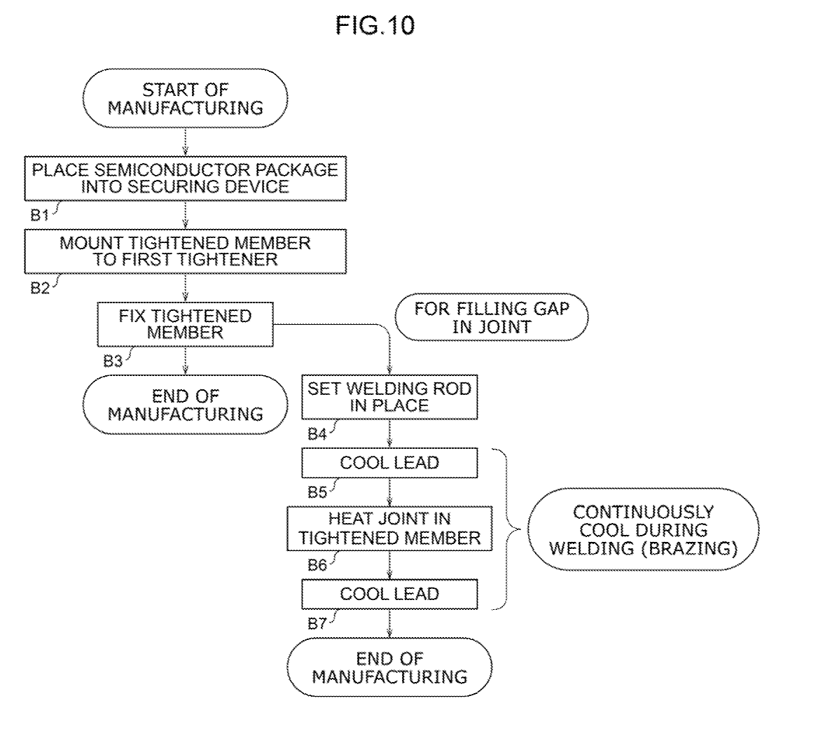

FIG. 10 is a process chart illustrating one example of a method of forming a solder dam (manufacturing process chart). In this chart, controls in a single control cycle for forming solder dams 4 are arranged chronologically.

In Step B1, a semiconductor package 3 is secured to a securing device 21. In this step, leads 1 are secured to a working table 20. In subsequent Step B2, a tightened member 13 is mounted to a first tightening member 11. The tightened member 13 is supported to the first tightening member 11 via spacers 11a. In this step, the relative location of the tightened member 13 with respect to a lead 1 is fine adjusted by adjusting the locations of the spacers 11a. Note that “mount” means preparing for attachment of the tightened member 13 to the lead 1.

In subsequent Step B3, the first and second tightening members 11 and 12 are displaced to the directions indicated by Arrows C and C′ in FIG. 8A, respectively. In this step, the abutted portion 13a of the tightened member 13 abuts against one surface 1c of the lead 1, and the tips of the bent portions 13b contact the depressed portion 12a of the second tightening member 12. The bent portions 13b that are pressed by the second tightening member 12 bend toward the inside of the tightened member 13 at the notches 13c, thereby the tightened member 13 being tightened annually so as to surround the lead 1. In the process described above, the semiconductor package 3 having solder dams 4 formed on the leads 1 is manufactured.

Note that optional Step B4 may be performed if there is a gap between the tips of the pair of bent portions 13b of the tightened member 13 after being tightened. For example, in Step B4, the tip of the welding rod 7 is set in place through manual operations of the manipulators 9, and the tip of the welding rod 7 is moved to a location where the tip of the welding rod 7 is brought closer to the gap in the ring member 5.

In subsequent Step B5, the cooler 22 is operated to initiate cooling of the lead 1. In subsequent Step B6, the tip of the welding rod 7 is heated to an elevated temperature to braze the gap in the tightened member 13, thereby forming looped solder dams 4.

Note that cooling of the lead 1 by the cooler 22 is also continued during this step, in order to prevent the lead 1 from being curled or bent due to the heat of the welding rod 7. The cooler 22 is continuously operated to cool the lead 1 in subsequent Step B7, until the filled gap in the tightened member 13 is cooled. In the process described above, the semiconductor package 3 having solder dams 4 without any joint is manufactured.

### 2-3. Effects

Tightening solder-repellent square C-shaped tightened members 13 on a lead 1 at predetermined locations can increase the precisions of the dislocation and the width of the solder dams 4. More specifically, the locations at which the solder dams 4 are to be formed can be fine adjusted by the spaces 11a, and accordingly the precision of dislocation can be easily improved. In addition, since the width of the solder dams 4 is determined by the thickness D₂ of the tightened members 13, the precision of formation of the solder dams 4 can be significantly improved as the precision of manufacturing of the tightened members 13 increases.

In addition, since the first and second tightening members 11 and 12 are guided on predefined rails, it is possible to make the tips of the bent portions 13b to accurately abut against the depressed portion 12a during tightening, whereby improving the uniformity of the shape of tightened portions. This can further enhance the precision of the shape of the solder dams 4.

In addition, even if a gap is formed in the tightened member 13 during tightening, the gap can be filled by brazing by heating the material of the tightened member 13, to form a looped solder dam 4.

Note that the thickness D₂ of tightened members 13 can be set to any desirable value, depending on the requirement on the width of solders dams 4. More preferably, the thickness D₂ of the tightened member 13 is set in a range from 0.1 mm to 1.0 mm. Within this range, minuscule solder dams 4 can be formed while maintaining the strength and durability required for the tightened members 13.

### 3. Third Embodiment

### 3-1. Construction

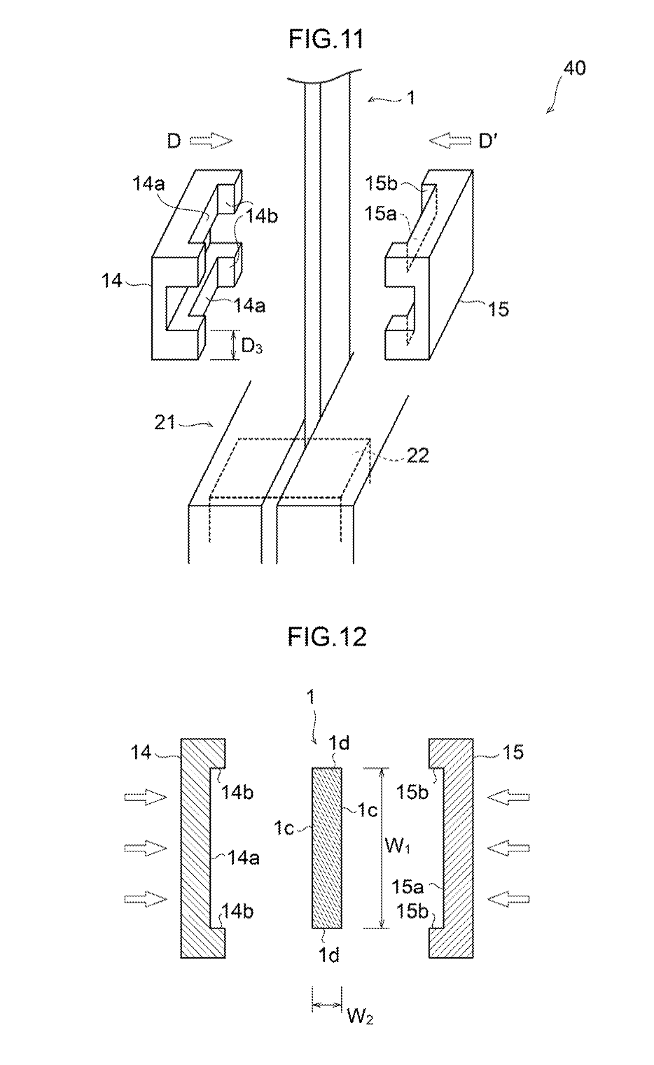

A solder dam formation apparatus 40 adapting a method of forming a solder dam according to a third embodiment will be described with reference to FIG. 11. While tightened members 13 are secured to a lead 1 by means of tightening in the second embodiment, ink is applied on a lead by transferring the ink in the third embodiment.

The ink contains a material that prevents, after being dried, adhesion of a solder, i.e., a material that reduces the wettability of the solder. The ink also contains a material that exhibits heat resistance at the melting point of the solder. For example, a pigment, oil-based ink, and water-based ink containing a synthetic polymer resin, such as a silicone resin, an epoxy resin, a polyimide resin, as the main component, may be used.

The solder dam formation apparatus 40 includes a first presser 14 and a second presser 15 (engaging members) for transferring ink. The first presser 14 and the second presser 15 are stamps for transferring ink, and are made from a resin, such as a sponge or polyurethane rubber, or a metal, such as an aluminum alloy, brass, a stainless steel, or a rigid felt impregnated with a resin.

After the ink is applied on both the first presser 14 and the second presser 15, they are engaged with the lead 1. Thereby, the ink is sandwiched between and pressed by the first and second pressers 14 and 15, causing the ink to be adhered to the surfaces 1c and the side cuts 1d of the lead 1. The directions of pressing by the first and second pressers 14 and 15 are indicated by Arrows D and D′ in FIG. 11, respectively.

Note that the first and second pressers 14 and 15 are guided on predefined rails secured at predetermined locations, and their loci are on a single straight line (or a single curved line). Similar to the first embodiment, the semiconductor package 3 is secured to a securing device 21 disposed on a working table 20. Although no cooler 22 is required to be included the securing device 21 in the third embodiment, a cooler 22 is not necessarily useless. For example, the lead 1 may be cooled by operating a cooler 22 if the temperature of the ink is high.

On the first presser 14, first disposing surfaces 14a that come into surface contact with one of the surfaces 1c of the lead 1, and pairs of second disposing surfaces 14b that come into surface contact with portions of the side cuts 1d closer to the surface 1c of the lead 1, are provided. The second disposing surfaces 14b extend in the direction perpendicular to the respective rectangular-shaped first disposing surfaces 14a from the two ends of the first disposing surfaces 14a.

Ink is applied on both the first disposing surfaces 14a and the second disposing surfaces 14b at a certain thickness. As depicted in FIG. 11, the height D₃ of the first disposing surfaces 14a and the second disposing surfaces 14b (i.e., the length of the two sides of the first disposing surfaces 14a on which no second disposing surface 14b is provided) can be set to any suitable value, in accordance with the desirable dam width of the solder dams 4 to be formed. Preferably, the thickness D₃ is set in a range from 0.1 mm to 1.0 mm.

The second presser 15 is shaped the same as the first presser 14, and includes a first disposing surfaces 15a that come into surface contact with the other surface 1c of the lead 1 and pairs of second disposing surfaces 15b that come into surface contact with the side cuts 1d. When the first and second pressers 14 and 15 are pressed against the lead 1, the lead 1 is engaged with each of the first and second pressers 14 and 15 and comes into surface contact with all of the first disposing surfaces 14a and 15a and the second disposing surfaces 14b and 15b. As depicted in FIG. 12, assuming that the surfaces 1c of the lead 1 have a width of W₁ and the side cuts 1d have a width of W₂, the first disposing surfaces 14a and 15a will have a width of W₁ and the protrusions of the second disposing surfaces 14b and 15b from the first disposing surfaces 14a and 15a will be W₂/2 long (a half of W₂).

### 3-2. Process Chart

FIG. 13 is a process chart (production flow chart) illustrating one example of a method of forming a solder dam. In this chart, controls in a single control cycle for forming solder dams 4 are arranged chronologically.

In Step C1, a semiconductor package 3 is secured to a securing device 21. In this step, leads 1 are secured to a working table 20. In subsequent Step C2, ink is applied on the first and second pressers 14 and 15. In this example, the ink is applied evenly on all of the first disposing surfaces 14a and 15a and the second disposing surfaces 14b and 15b.

In subsequent Step C3, the first and second pressers 14 and 15 are displaced to the directions indicated by Arrows D and D′ in FIG. 11, respectively. In this step, the first disposing surfaces 14a of the first presser 14 come into surface contact with one of the surfaces 1c of the lead 1, and the first disposing surfaces 15a of the second presser 15 come into surface contact with the other surface 1c of the lead 1. At the same time, the side cuts 1d of the lead 1 come into surface contact with the second disposing surfaces 14b and 15b, thereby the entire periphery of the lead 1 being encircled by the first and second pressers 14 and 15.

In subsequent Step C4, each of the first and second pressers 14 and 15 are displaced to the directions away from the lead 1. Transfer of the ink to the lead 1 is completed in this step. In subsequent Step C5, the ink transferred to the surfaces 1c and the side cuts 1d of the lead 1 is allowed to dry. Alternatively, the ink transferred to the lead 1 is forcefully dried with a dryer.

The dried and adhered ink is configured to function as the solder dams 4. In the processes described above, the semiconductor package 3 having solder dams 4 formed on the leads 1 is manufactured.

### 3-3. Applications and Effects

Application of ink on a lead 1 by means of the first and second pressers 14 and 15 that are engaged with the lead 1 can increase the precisions of the dislocation and the width of the solder dams 4. More specifically, since the locations at which the solder dams 4 are to be formed are determined uniquely from the relative location between the first and second pressers 14 and 15 and the lead 1, and accordingly the precision of dislocation of the solder dams 4 can be easily improved. In addition, since the width of the solder dams 4 is determined by the height D₃ of the first disposing surfaces 14a and 15a and the second disposing surfaces 14b and 15b, the precision of formation of the solder dams 4 can be significantly improved as the precision of manufacturing of the first disposing surfaces 14a and 15a and the second disposing surfaces 14b and 15b increases.

Note that the height D₃ of the first disposing surfaces 14a and 15a and the second disposing surfaces 14b and 15b can be set to any desirable value, depending on the requirement on the width of solders dams 4. More preferably, the height D₃ of the first disposing surfaces 14a and 15a and the second disposing surfaces 14b and 15b is set in a range of 0.1 mm to 1.0 mm. Within this range, minuscule solder dams 4 can be formed while maintaining the strength and durability required for the first disposing surfaces 14a and 15a and the second disposing surfaces 14b and 15b.

### 4. Variants

Note that with regard to the embodiments described above, various modifications may be made without departing from the spirit of the present embodiments. Constructions and processes of the present embodiments may be selected or suitably combined where necessary.

Although an operator forms solder dams 4 on a lead 1 by operating manipulators 9 in the first embodiment described above, the process depicted in FIG. 6 may be automated, for example. In such a case, the locations at which solder dams 4 are to be formed can be precisely controlled by specifying locations on a lead to form solder dams 4 (the relative locations and orientations of the solder dams 4 with respect to a working table 20) in advance.

In addition, although ring members 5 are brazed to the lead 1 in the first embodiment, the ring members 5 may be melt-welded, instead of brazing. For example, in the case where a lead 1 is sufficiently thick as compared to the thickness of solder dams 4, the ring member 5 and the lead 1 may be molten and attached together.

In addition, a retention hand 6 has been described as being shared in a semi-circular arc in the above-described first embodiment, a retention device in a shape of tweezers including a pair of arms may be used, instead of the retention hand 6. In addition, an anti-slip member may be attached onto gripping surfaces 6d, for the purpose of increasing the ability of the retention hand 6 to hold a ring member 5. Alternatively, a groove may be formed on gripping surfaces 6d for holding a ring member 5 in order to prevent the ring member 5 from being slipped. In other words, an articulated robot arm can have any desirable construction.

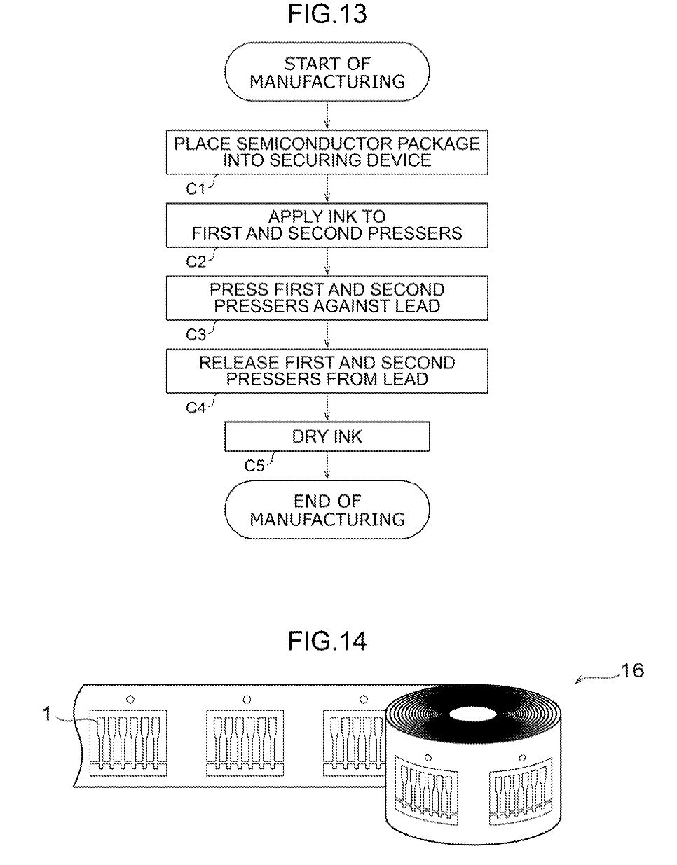

In addition, although the solder dam formation apparatuses 10, 30, and 40 for forming solder dams 4 on a lead 1 of a semiconductor package 3 have been described in the embodiments above, solder dams 4 may be formed to other targets. For example, as depicted in FIG. 14, solder dams 4 may be formed on a strip lead frame 16 having multiple leads 1 before separated from a metal plate. In such a case, securing one end of lead frame 16 on a securing device 21 can provide the same effects as the above-described embodiments.

Note that, with regard to the embodiments and variants described above, various modifications may be made without departing from the spirit of the present embodiments. The embodiments may be practiced or manufactured by those ordinarily skilled in the art with reference to the above disclosure.

In accordance with the technique described above, the precisions of the dislocation of solder dams 4 can be increased, as well as enabling formations of minuscule solder dams.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A method of forming a solder dam on a lead of an electronic component, the method comprising:
forming the looped solder dam surrounding a target lead, to which the solder dam is to be formed, of a plurality of leads connected to the electronic component, by fitting a C-shaped fitted member to the target lead at a predetermined location.

2. The method of forming a solder dam according to claim 1, wherein the fitted member is a metal member which is resistant to adhesion of the solder.

3. The method of forming a solder dam according to claim 2, further comprising welding or brazing the metal member after fitting the metal member to the target lead.

4. The method of forming a solder dam according to claim 1, further comprising tightening the metal member after fitting the fitted member to the target lead.

5. The method of forming a solder dam according to claim 4, wherein the entire fitted member fitted to the target lead is heated.

6. The method of forming a solder dam according to claim 1, further comprising providing the fitted member with ink that prevents adhesion of the solder, and transferring the ink to the target lead.

7. The method of forming a solder dam according to claim 6, further comprising drying the ink transferred to the target lead to fixing the ink.

8. A method of forming a solder dam on a lead of an electronic component, the method comprising:
fitting a square C-shaped fitted member, at a predetermined location, to a target lead, to which the solder dam is to be formed, of a plurality of leads connected to the electronic component; and
forming the looped solder dam surrounding the target lead by welding or brazing a joint in the fitted member fitted to the target lead.

9. A method of forming a solder dam on a lead of an electronic component, the method comprising:
applying an ink on a square C-shaped engaging member that is shaped so as to correspond to a target lead, to which the solder dam is to be formed, of a plurality of leads connected to the electronic component; and
fitting the engaging member having the ink applied thereon to the target lead at a predetermined location to transfer the ink to the target lead; and
drying the ink transferred to the target lead to form the looped solder dam surrounding the target lead.
